(19) United States
(12) Patent Application Publication
(10) Pub. No.: US 2025/0006419 A1
(43) Pub. Date: Jan. 2, 2025

(54) MAGNETIC COMPONENT WITH SHIELDING

(71) Applicant: Würth Elektronik eiSos GmbH & Co. KG, Waldenburg (DE)

(72) Inventor: Tan Lung CHING, New Taipei City (TW)

(21) Appl. No.: 18/758,959

(22) Filed: Jun. 28, 2024

(30) Foreign Application Priority Data
Jun. 29, 2023 (TW) 112 206 720
Jan. 22, 2024 (CN) U007179AAE

(51) Int. Cl. H01F 27/28; H01F 27/32

(52) U.S. Cl. CPC H01F 27/2885; H01F 27/324

(57) ABSTRACT

A magnetic component with shielding comprises: a magnetic component including a body and a plurality of pin portions; and an electrically conductive coating disposed on a surface of the magnetic component, wherein the electrically conductive coating is insulated from each of the pin portions. In the invention, the electrically conductive coating covers an outer surface of the magnetic component as a shield, such that the shield completely encloses the outer surface of the magnetic component without leaving any gaps. The magnetic component with shielding according to the invention offers manufacturing advantages over the conventional art in which a housing must be provided to serve as a shield.

### TECHNICAL FIELD

The invention relates to a magnetic component, particularly to a magnetic component with an electrically conductive coating on an outer surface thereof.

### BACKGROUND

In this area of technology, there is a trend towards miniaturization of various electronic devices, and maximization of power density in circuit boards, as well as reducing the spacing among electronic components on circuit boards. Many of these components, including magnetic components such as inductors and transformers, and the like, operate based on the principles of magnetism. Such magnetic components may emit magnetic fields, generating electromagnetic interference that may affect the functioning of nearby components. In applications requiring high stability, such as automotive electronics, it is essential to carefully manage the effects of electromagnetic interference.

In view of the foregoing, an inductor with shielding has been developed. For example, Taiwanese Patent under Publication No. TWI734771 discloses an inductor that includes a housing acting as a shield over an inductor body. However, due to the material properties of the molded inductor itself, the outer dimensions of the molded inductor are prone to slight tolerances. In this case, if the inductor body is to be combined with a preformed housing, a gap may occur therebetween and no close contact can be achieved. Moreover, if an excessive pressure is applied in order to clamp the housing and the inductor body during combination, the inductor body may be damaged. Furthermore, processing the housing into a complex shape that perfectly fits the inductor body is challenging. In the prior art, a gap is usually left at the corner to facilitate the bending process, as shown in the representative drawing (FIG. 4) of the above-mentioned prior patent. Therefore, there is a need for further improvement in respect of coverage and the connection between the shield and the inductor body in a fit manner.

In view of this, the inventor, having many years of research and practical experience in related fields, has designed a magnetic component with shielding to overcome the drawbacks of the above-mentioned conventional techniques.

### Content

The main purpose of the invention is to provide a magnetic component with an improved shielding.

To this end, a magnetic component with shielding according to the invention comprises: a magnetic component including a body and a plurality of pin portions; and an electrically conductive coating disposed on a surface of the magnetic component, wherein the electrically conductive coating is insulated from each of the pin portions. The electrically conductive coating may be formed by spraying and coating a metal-based electrically conductive material, such as a metal-based electrically conductive material containing silver particles, copper particles, or silver-plated copper particles. The electrically conductive coating disposed on the outer surface of the magnetic component serves as an entire and well-fitted shield.

The electrically conductive coating on the outer surface of the magnetic component can form a complete seamless shield, thereby minimizing the likelihood of magnetic field leakage. Furthermore, the shielding effect can be enhanced by increasing the thickness of the electrically conductive coating to meet the requirements of various applications.

The magnetic component includes at least one of an inductor and a transformer, which is encased by the body and electrically connected to the plurality of pin portions.

If the surface of the magnetic component is not suitable for direct contact with the electrically conductive coating that has electrical conductivity, an insulating coating may be interposed between the body and the electrically conductive coating. Furthermore, if a ground terminal is present on the surface of the magnetic component, it is necessary to ensure that the insulating coating does not cover the ground terminal.

Since the shield must be grounded, if the surface of the magnetic component does not have a ground terminal, a ground lug can be provided on the body. The ground lug is electrically connected to the electrically conductive coating. Given that the electrically conductive coating can completely enclose the magnetic component, the ground lug may be positioned on the surface that is exactly closest to grounding point. Unlike conventional techniques, the ground lug does not need to extend from a top surface all the way down. If both the insulating coating and the ground lug are to be provided, the insulating coating may be provided first, followed by the ground lug, since the ground lug does not serve for electrically conducting with the body. Alternatively, the ground lug may be provided first, followed by covering with a mask and applying an insulating coating. Once the insulating coating is applied, the mask on the ground lug can be removed.

To prevent oxidation of the electrically conductive coating, a protective coating may be applied over the electrically conductive coating. If necessary, the ground lug or the original ground terminal of the magnetic component can be masked prior to the application of the protective coating to ensure that the protective coating does not cover the ground lug or the original ground terminal of the magnetic component.

The protective coating may also have an opening in at least one predetermined position. For example, before applying the protective coating, the predetermined position on the electrically conductive coating is masked. After application, the mask is removed, leaving an opening on the protective coating. The opening exposes a portion of electrically conductive coating, where a ground electrode is formed. Accordingly, the electrically conductive coating may have at least one ground electrode positioned at a location corresponding to the opening.

The inventive method can be further defined by at least one feature described in connection with the inventive magnetic component with shielding.

In order to clearly and fully disclose the invention, drawings of the preferred embodiments are provided to describe the implementations thereof in detail as follows:

### BRIEF DESCRIPTION OF DRAWINGS

FIG. 1 is a perspective view of Embodiment (1) according to the invention.

FIG. 2 is a cross-section view (1) of Embodiment (1) according to the invention.

FIG. 3 is a cross-section view (2) of Embodiment (1) according to the invention.

FIG. 4 is a perspective view of Embodiment (2) according to the invention.

FIG. 5 is a cross-section view of Embodiment (2) according to the invention.

### DETAILED DESCRIPTION

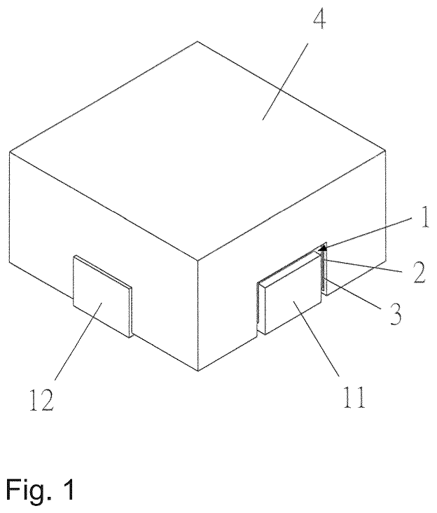

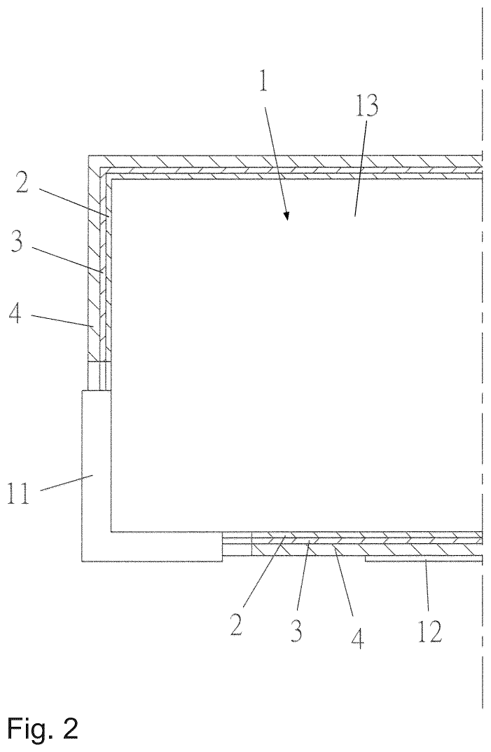

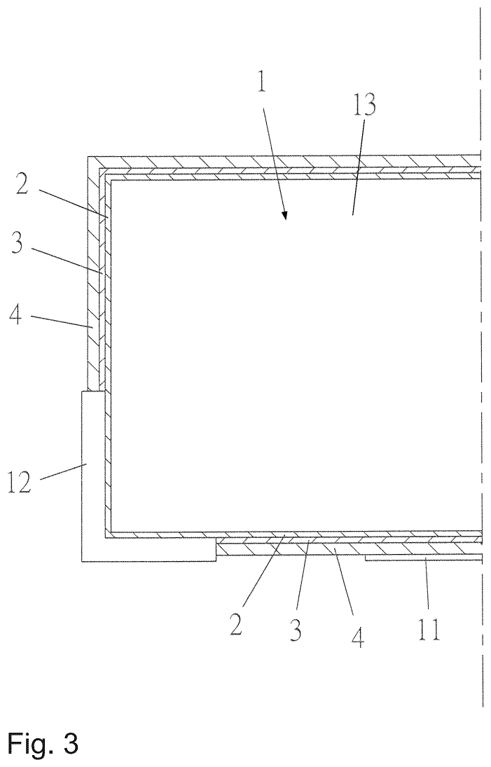

FIGS. 1 to 3 are drawings illustrating the embodied implementations of the invention. Referring to FIGS. 1 to 3, a magnetic component with shielding according to Embodiment (1) of the invention comprises: a magnetic component 1 including a body 13 and a plurality of pin portions 11; and an electrically conductive coating 3 disposed on a surface of the magnetic component 1. The electrically conductive coating 3 is insulated from each of the pin portions 11. In Embodiment (1), as shown in FIG. 1, each of the pin portions 11 is masked when spraying to form the electrically conductive coating 3, that is, each of the pin portions 11 is not in contact with the electrically conductive coating 3. Therefore, the electrically conductive coating 3 is insulated from each of the pin portions 11.

The magnetic component 1 includes at least one of an inductor and a transformer, which is encased by the body 13 and electrically connected to the plurality of pin portions 11.

According to Embodiment (1), an insulating coating 2 is provided between the body 13 and the electrically conductive coating 3. Furthermore, according to Embodiment (1), at least one ground lug 12 (two ground lugs 12 are shown in the drawings) is disposed on the body 13. The ground lug 12 is electrically connected with the electrically conductive coating 3. Furthermore, according to Embodiment (1), a protective coating 4 is provided outside the electrically conductive coating 3. According to Embodiment (1), when spraying to form the insulating coating 2 and the protective coating 4, each of the pin portions 11 is masked, and there is a gap between the insulating coating 2, the protective coating 4, and each pin portion 11.

The electrically conductive coating 3 on the magnetic component 1 may form a completely seamless shield on an outer surface of the body 13. Unlike the conventional shielding housing that tends to leave gaps (e.g., at corners) during processing, the body 13 in Embodiment (1) is a cuboid, and all six sides of the body 13 may be coated with the electrically conductive coating 3, minimizing the likelihood of magnetic field leakage. Moreover, the electrically conductive coating 3, applied via spraying, can easily conform to the complex and undulating outer surface of the magnetic component 1. In contrast, utilizing a mechanically processed housing for a complex and undulating outer surface could significantly increase machining costs. The shielding effect can be enhanced by increasing the thickness of the electrically conductive coating 3 to meet the requirements of various applications. However, increasing the thickness of the mechanically processed housing may give rise to challenges in the bending process during fabrication.

In Embodiment (1), considering that the body 13 of the magnetic component 1 should not make direct contact with the electrically conductive coating 3 that has electrical conductivity, an insulating coating 2 is interposed between the body 13 and the electrically conductive coating 3. Furthermore, if a ground terminal (not shown) is provided on the surface of the magnetic component 1, it is necessary to ensure that the insulating coating 2 does not cover the ground terminal (not shown).

Since the shield must be grounded, in Embodiment (1), considering that the magnetic component 1 has no ground terminal (not shown), a ground lug 12 is provided on the body 13 and is electrically connected to the electrically conductive coating 3. Given that the electrically conductive coating 3 can completely enclose the magnetic component 1, the ground lug 12 may be positioned on the surface that is exactly closest to the grounding point. Unlike conventional techniques, the ground lug 12 does not need to extend from a top surface all the way down. If both the insulating coating 2 and the ground lug 12 are to be provided, the insulating coating 2 may be provided first, followed by the ground lug 12, since the ground lug 12 does not serve for electrically conducting with the body. Alternatively, the ground lug 12 may be provided first, followed by covering with a mask and applying the insulating coating 2. Once the insulating coating 2 is applied, the mask on the ground lug 12 can be removed.

In Embodiment (1), to prevent oxidation of the electrically conductive coating 3, a protective coating 4 may be applied over the electrically conductive coating 3. If necessary, the ground lug 12 or the original ground terminal (not shown) of the magnetic component 1 can be masked prior to application of the protective coating 4 to ensure that the protective coating 4 does not cover the ground lug 12 or the original ground terminal (not shown) of the magnetic component 1.

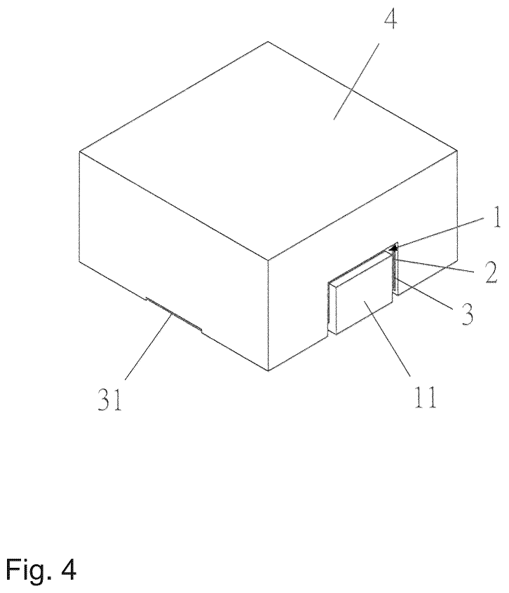

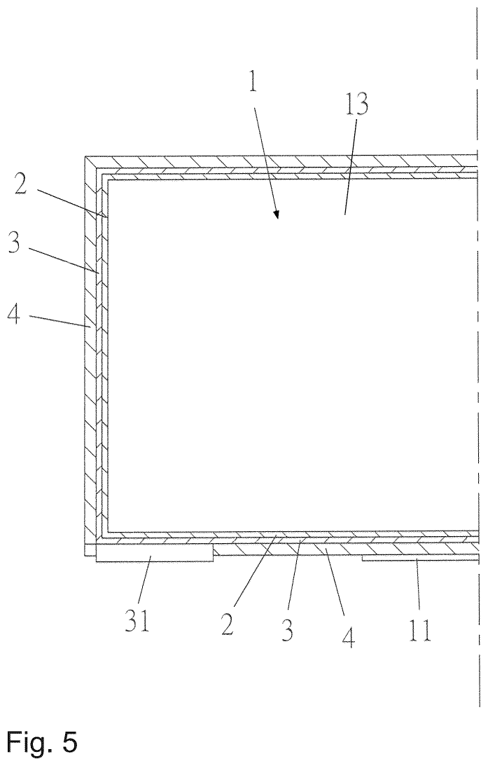

The protective coating 4 according to the invention may include an opening in at least one predetermined position, as shown in FIGS. 4 and 5. In Embodiment (2), before application of the protective coating 4, the predetermined position on the electrically conductive coating 3 is masked (in Embodiment (2), both opposite sides are masked). After application, the mask is removed, leaving an opening in the protective coating 4. The opening exposes a portion of electrically conductive coating 3, where a ground electrode 31 is formed. Accordingly, the electrically conductive coating 3 may have at least one ground electrode 31 positioned at a location corresponding to the opening. The ground electrode 31 may be formed using an electroplating method. Moreover, the mask of the pin portions 11 is removed after the formation of the ground electrode 31, ensuring that each of the pin portions 11 remains unaffected by the electroplating process.

Although the preferred embodiments have been described for illustrative purposes, those skilled in the art would appreciate that various modifications, additions, and substitutions are possible, without departing from the scope and spirit of the invention.

### DESCRIPTION OF THE REFERENCE NUMERALS

1: Magnetic component
11: Pin portion
12: Ground lug
13: Body
2: Insulating coating
3: Electrically conductive coating
31: Ground electrode
4: Protective coating

1. A magnetic component with shielding, comprising:
a magnetic component including a body and a plurality of pin portions; and
an electrically conductive coating disposed on a surface of the magnetic component, the electrically conductive coating being insulated from each of the pin portions.

2. The magnetic component with shielding of claim 1, further comprising an insulating coating between the body and the electrically conductive coating.

3. The magnetic component with shielding of claim 1, further comprising at least one ground lug on the body, the at least one ground lug being electrically connected with the electrically conductive coating.

4. The magnetic component with shielding of claim 1, further comprising a protective coating outside of the electrically conductive coating.

5. The magnetic component with shielding of claim 4, wherein the protective coating includes an opening in at least one predetermined position, and at least one ground electrode is provided on the electrically conductive coating at a location corresponding to the opening.

6. The magnetic component with shielding of claim 5, wherein the at least one ground electrode is electroplated.

7. The magnetic component with shielding of claim 1, wherein the electrically conductive coating forms a complete seamless shield.

8. The magnetic component with shielding of claim 1, wherein the electrically conductive coating is formed by spraying and coating a metal-based electrically conductive material.

9. The magnetic component with shielding of claim 1, wherein the electrically conductive coating comprises at least one of silver particles, copper particles and silver-plated copper particles.

10. The magnetic component with shielding of claim 3, wherein the electrically conductive coating completely encloses the magnetic component and the at least one ground lug is positioned on a surface of the magnetic component that is exactly closest to a grounding point.

11. The magnetic component with shielding of claim 1, wherein the body is a cuboid and all six sides of the body are coated with the electrically conductive coating.

12. The magnetic component with shielding of claim 1, wherein the magnetic component includes at least one of an inductor and a transformer.

13. A method of manufacturing a magnetic component with shielding, comprising the steps:
providing a magnetic component including a body and a plurality of pin portions; and
disposing an electrically conductive coating on a surface of the magnetic component, wherein the electrically conductive coating is insulated from each of the pin portions.
